(19) United States
(12) Patent Application Publication
(10) Pub. No.: US 2025/0112998 A1
(43) Pub. Date: Apr. 3, 2025

(54) INFORMATION PROCESSING APPARATUS, CONTROL METHOD THEREOF, INFORMATION PROCESSING SYSTEM, AND STORAGE MEDIUM

(71) Applicant: CANON KABUSHIKI KAISHA, Tokyo (JP)

(72) Inventors: REI ISHIKAWA, Saitama (JP); NAOKO YAMAMOTO, Kanagawa (JP)

(21) Appl. No.: 18/894,086

(22) Filed: Sep. 24, 2024

(30) Foreign Application Priority Data
Sep. 29, 2023 (JP) 2023-170866

(51) Int. Cl. H04N 1/00

(52) U.S. Cl. CPC H04N 1/00209; H04N 1/00464

(57) ABSTRACT

An information processing apparatus comprising: a storage unit configured to store a plurality of images; a reception unit configured to receive one or more narrowing conditions from an external apparatus; a generation unit configured to generate one or more pieces of first link information each representing a link to a screen displaying an image satisfying each of the one or more narrowing conditions among the plurality of images; and a transmission unit configured to transmit the one or more pieces of first link information to a transmission destination designated by the external apparatus.

### BACKGROUND OF THE INVENTION

### Field of the Invention

The present invention relates to an information processing apparatus, a control method thereof, an information processing system, and a storage medium.

### Description of the Related Art

Known information processing apparatuses that store images and can be connected to terminals via a network have been widely used. The information processing apparatus generates and transmits, to a terminal connected to the network, an image display screen displaying an image stored in the apparatus. The user can perform an operation of browsing images stored in the information processing apparatus or sharing these images with another user via the terminal. When sharing an image with another user, the user who is a sender of the image causes the information processing apparatus to generate link information for sharing, for example, a URL, and transmits the link information to the other user who is a recipient of the image. By designating the transmitted link information with the terminal, the recipient can cause the information processing apparatus to generate an image display screen displaying the shared image.

There is a case where the recipient desires to browse only some of the images sent by the sender. This is because there is a case where, for example, when the sender sends images in which a person appears, the recipient is interested only in an image in which the recipient himself/herself or a family member of the recipient appears and does not desire to view other images. Therefore, there is a technique for narrowing down an image to be displayed by a recipient performing an operation on an image display screen. Japanese Patent Laid-Open No. 2017-097552 discloses a technique of changing an image to be displayed based on a search word input by a recipient.

### SUMMARY OF THE INVENTION

According to Japanese Patent Laid-Open No. 2017-097552, in a case where an information processing apparatus generates a screen displaying a large number of images, an image to be displayed can be decided in response to an operation of the recipient. However, it is necessary for the recipient himself/herself to designate a display condition of the image, which deteriorates convenience of the recipient.

According to one aspect of the present invention, there is provided an information processing apparatus comprising: a storage unit configured to store a plurality of images; a reception unit configured to receive one or more narrowing conditions from an external apparatus; a generation unit configured to generate one or more pieces of first link information each representing a link to a screen displaying an image satisfying each of the one or more narrowing conditions among the plurality of images; and a transmission unit configured to transmit the one or more pieces of first link information to a transmission destination designated by the external apparatus.

Further features of the present invention will become apparent from the following description of exemplary embodiments (with reference to the attached drawings).

### BRIEF DESCRIPTION OF THE DRAWINGS

FIGS. 1A to 1C are views illustrating hardware configuration examples of an information processing system and an information processing apparatus according to a first embodiment.

FIG. 2 is a view illustrating a software configuration example of the information processing apparatus according to the first embodiment.

FIG. 3 is a flowchart showing an operation example of the information processing apparatus according to the first embodiment.

FIGS. 4A to 4D are views illustrating examples of a display screen on a terminal of a sender according to the first embodiment.

FIGS. 5A and 5B are views illustrating examples of a display screen on a terminal of a recipient according to the first embodiment.

FIG. 6 is a flowchart showing an operation example of an information processing apparatus according to a variation example of the first embodiment.

FIGS. 7A to 7C are views illustrating examples of a display screen on a terminal of a recipient according to the variation example of the first embodiment.

FIG. 8 is a view illustrating a software configuration example of the information processing apparatus according to a second embodiment.

FIG. 9 is a flowchart showing an operation example of the information processing apparatus according to the second embodiment.

FIGS. 10A to 10E are views illustrating examples of a display screen of a terminal of a recipient according to the second embodiment and examples of total narrowing information.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### Hardware Configuration

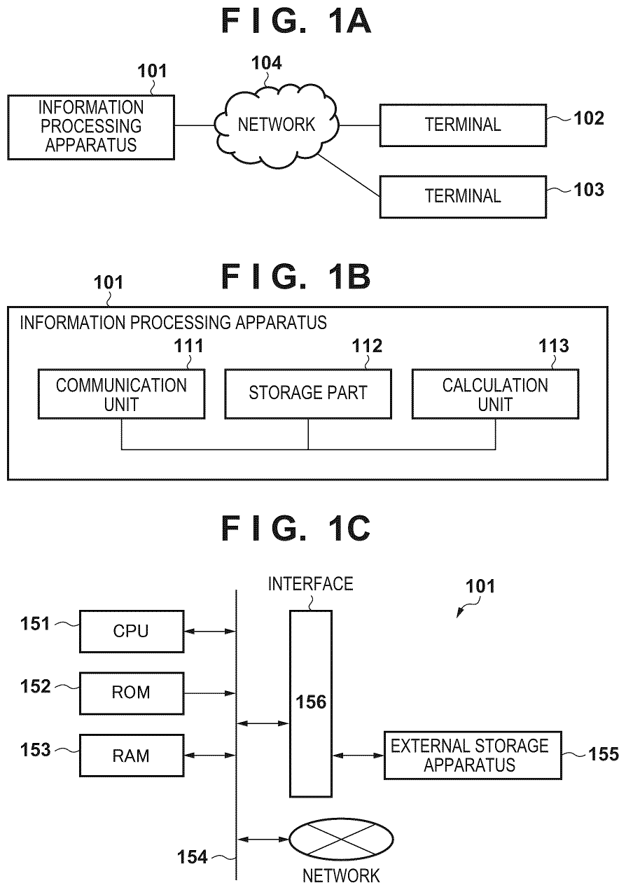

FIG. 1A is a view illustrating a configuration example of an information processing system according to the first embodiment. An information processing apparatus 101 is connected to a terminal 102 and a terminal 103 via a network 104. In the following description, it is assumed that the terminal 102 is owned by a sender who sends an image, and the terminal 103 is owned by a recipient who receives the image. The numbers of information processing apparatuses and terminals are not limited to the illustrated numbers. The information processing apparatus 101 has a function of storing images, a function of receiving inputs from the terminals 102 and 103, and a function of transmitting screens to the terminals 102 and 103.

FIG. 1B is a block diagram illustrating a functional configuration example implemented by hardware of the information processing apparatus 101. The information processing apparatus 101 includes a communication unit 111, a storage part 112, and a calculation unit 113 as functional units, and operates as a server on a cloud, for example. The terminals 102 and 103 are implemented by an electronic device different from the information processing apparatus 101, such as a smartphone, a tablet, or a personal computer, for example. The communication unit 111 of the information processing apparatus 101 is implemented by, for example, a network card or the like, and transmits and receives information to and from the terminals 102 and 103 via the network 104. The storage part 112 is implemented by, for example, a random access memory (RAM) 153, a read only memory (ROM) 152, an external storage apparatus 155, and the like described later with reference to FIG. 1C, and stores an image and the like. The calculation unit 113 executes data transmission/reception and storage processing. The calculation unit 113 is implemented by, for example, a central processing unit (CPU) 151 described later with reference to FIG. 1C, a graphics processing unit (GPU) not illustrated, or the like. The calculation unit 113 implements an image processing service of the present embodiment by executing a program stored in the storage part 112.

FIG. 1C is a block diagram illustrating a configuration example of a computer system used in the information processing apparatus 101 of the present embodiment. The CPU 151 executes an operating system (OS) and various application programs and controls each unit of a computer apparatus. The ROM 152 stores fixed data among programs executed by the CPU 151 and parameters for calculation. The RAM 153 provides a work area of the CPU 151 and a temporary storage area of data. The ROM 152 and the RAM 153 are connected to the CPU 151 via a bus 154. An external storage apparatus 155 such as a hard disk drive (HDD), a magneto-optical disk (MO) drive, or a CD-ROM is connected to the bus 154 via an interface 156. The bus 154 is connected to the network 104. Note that the network 104 may be wired or wireless. Note that the hardware configurations of the terminal 102 and the terminal 103 are also similar to the configuration illustrated in FIG. 1C.

Hereinafter, in the present embodiment, a case where the image is a still image will be mainly described, but the image may be a moving image. That is, the information processing apparatus 101 can process any of a still image and a moving image. In the following description, unless otherwise specified, it is assumed that the term image includes concepts of both a moving image and a still image.

### Software Configuration

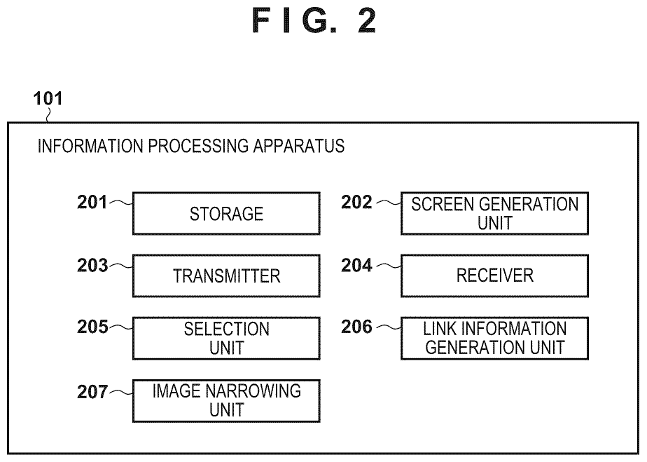

FIG. 2 illustrates an example of a software configuration of the information processing apparatus 101. The calculation unit 113 implements each functional unit illustrated in FIG. 2 by executing a predetermined program stored in the storage part 112.

A storage 201 stores an image in the storage part 112. A screen generation unit 202 generates a display screen displaying an image stored in the storage 201. Uses the communication unit 111, a transmitter 203 transmits a screen generated by the screen generation unit 202 to an external apparatus (e.g., the terminal 102 and the terminal 103) or the like. A receiver 204 receives a user input from the external apparatus (e.g., the terminal 102 and the terminal 103) via the communication unit 111. For example, the screen generated by the screen generation unit 202 includes a screen component that receives user input, such as a button, and is transmitted to the external apparatus by the transmitter 203. When the user operates the screen component in the external apparatus, information (operation information) corresponding to the operation is transmitted from the external apparatus to the information processing apparatus 101. The receiver 204 receives operation information transmitted from the external apparatus.

A selection unit 205 selects an image based on the operation information of the user received by the receiver 204. A link information generation unit 206 generates link information for causing the screen generation unit 202 to generate a display screen. The link information is transmitted to an external mail server or the like by the transmitter 203. An image narrowing unit 207 generates a narrowing condition for narrowing down an image based on a user input received by the receiver 204, and determines whether or not the image satisfies the narrowing condition. The screen generation unit 202 generates a display screen displaying an image determined by the image narrowing unit 207 to satisfy the narrowing condition.

### Transmission Processing of Link Information

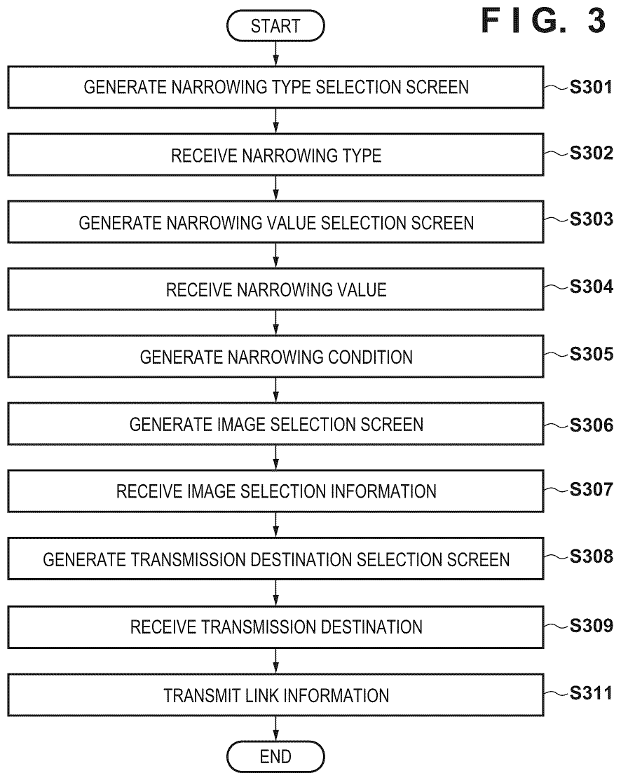

FIG. 3 is a flowchart showing an example of transmission processing of link information executed by the information processing apparatus 101. The processing shown in FIG. 3 is implemented by the calculation unit 113 of the information processing apparatus 101 executing a program stored in the storage part 112. The processing shown in FIG. 3 is started at the timing, for example, when the receiver 204 receives, from the terminal 102, an input instructing start of selection and transmission processing of an image.

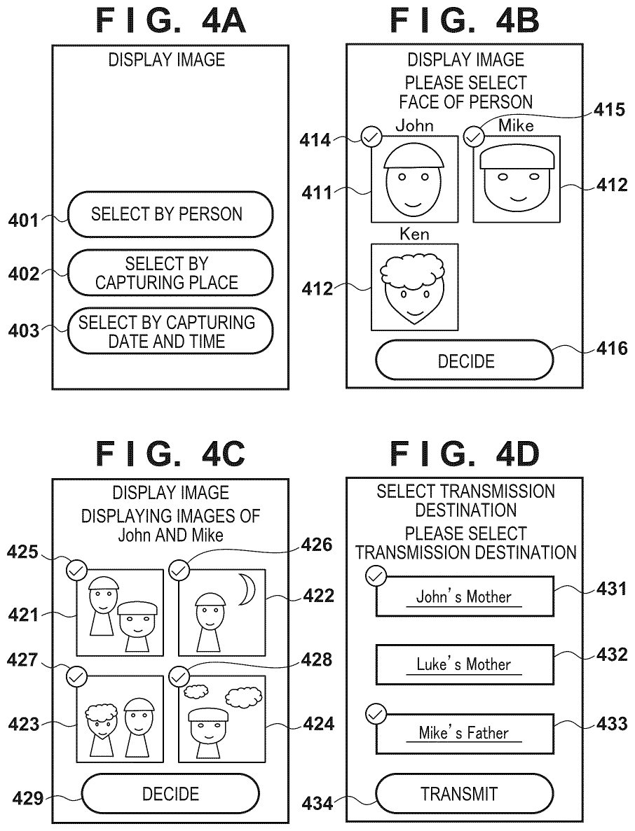

In S301, the screen generation unit 202 generates a selection screen of an image narrowing type (described later with reference to FIG. 4A), and the transmitter 203 transmits this to the terminal 102. The terminal 102 displays the selection screen of the narrowing type provided from the information processing apparatus 101 in this manner, and receives a user operation. In the present embodiment, the narrowing type is “person”, “capturing place”, and “capturing date and time”, and the user (sender of the image) of the terminal 102 can select the narrowing type from any of them by operating the selection screen. In the terminal 102, when a narrowing type is selected from the selection screen, the operation information is transmitted to the information processing apparatus 101, and in S302, the receiver 204 receives an input indicating the narrowing type.

In S303, the screen generation unit 202 generates a selection screen of a narrowing value, and the transmitter 203 transmits this to the terminal 102. The terminal 102 displays the selection screen of the narrowing value provided from the information processing apparatus 101 in this manner, and receives a user operation. The narrowing value displayed on the selection screen of the narrowing value is decided based on the narrowing type received in S302. In the present embodiment, for example, when the narrowing type is “person”, the narrowing value is, for example, the person's name (described later with reference to FIG. 4B). In a case where the narrowing type is “capturing place”, the narrowing value is a range of information indicating the capturing place, for example, latitude and longitude information. In a case where the narrowing type is “capturing date and time”, the narrowing value is information indicating the capturing date and time, for example, a date and time range. The user of the terminal 102 can select and designate the narrowing value by operating the selection screen. In the terminal 102, when the narrowing value is designated from the selection screen, the operation information is transmitted to the information processing apparatus 101, and in S304, the receiver 204 receives the narrowing value as an input indicating the narrowing value. Note that one or more narrowing values can be selected for one narrowing type.

In S305, the image narrowing unit 207 generates a narrowing condition based on the narrowing type received in S302 and the narrowing value received in S304. For example, the narrowing condition includes a pair of a narrowing type and a narrowing value. The image narrowing unit 207 determines whether or not the generated narrowing condition is satisfied for each of the plurality of images saved by the sender who owns the terminal 102. For example, in a case where the narrowing type is “person”, if the person indicated by the narrowing value appears in the image, the image narrowing unit 207 determines that the image satisfies the narrowing condition. In a case where the narrowing type is “capturing place”, if information on the capturing place embedded in the image is included in the range of the capturing place indicated by the narrowing value, the image narrowing unit 207 determines that the image satisfies the narrowing condition. In a case where the narrowing type is “capturing date and time”, if information on the capturing date and time embedded in the image is included in the range of the capturing date and time indicated by the narrowing value, the image narrowing unit 207 determines that the image satisfies the narrowing condition. Note that the narrowing target may be all the images saved by the sender or may be images stored in a specific folder among the images saved by the sender.

In S306, the screen generation unit 202 generates an image selection screen (described later with reference to FIG. 4C), and the transmitter 203 transmits this to the terminal 102. The terminal 102 displays the image selection screen provided from the information processing apparatus 101 in this manner, and receives a user operation. The image displayed on the image selection screen is an image satisfying any one of the narrowing conditions. That is, the images are all images narrowed down for each of a plurality of narrowing conditions. There is a case where the sender desires not to send all of the images selected based on the narrowing conditions but to send some of the images. Therefore, on the image selection screen, the sender can select an image to actually send. Since the sender can select, from an image group after narrowing down by the narrowing condition, an image of a transmission target or an image to be excluded from the transmission target, it is possible to efficiently select an image. The selection result by the operation on the image selection screen is transmitted as image selection information from the terminal 102 to the information processing apparatus 101. In S307, the receiver 204 receives the image selection information transmitted from the terminal 102. The image narrowing unit 207 excludes an image designated to be excluded from the transmission target by the image selection information from the narrowing result in accordance with each narrowing condition.

In S308, the screen generation unit 202 generates and transmits, to the terminal 102, a transmission destination selection screen (described later with reference to FIG. 4D). The terminal 102 displays the transmission destination selection screen provided from the information processing apparatus 101 in this manner, and receives a user operation. The transmission destination displayed on the transmission destination selection screen is stored by the storage 201. In the present embodiment, the transmission destination is an e-mail address and a transmission destination person name indicating the transmission destination person. The information indicating the transmission destination selected on the transmission destination selection screen is transmitted from the terminal 102 to the information processing apparatus 101. In S309, the receiver 204 receives the information indicating the transmission destination transmitted from the terminal 102.

In S310, the link information generation unit 206 generates link information based on the narrowing condition generated in S305 and the image selection information received in S307. The link information generation unit 206 generates pieces of link information by the number of narrowing conditions. As a display screen that each piece of link information generated here causes the screen generation unit 202 to generate, an image satisfying each narrowing condition is displayed among the images indicated by the image selection information received in S307. Each piece of link information to be generated has information on a corresponding narrowing condition. The link information generation unit 206 also generates link information for generating a display screen displaying all the images indicated by the image selection information received in S307. Note that the link information in this case does not have information on a corresponding narrowing condition. In S311, the transmitter 203 transmits the link information generated in S230 to the transmission destination received in S309, and ends the process of the present flowchart.

### Flow of Transmission Process of Link Information

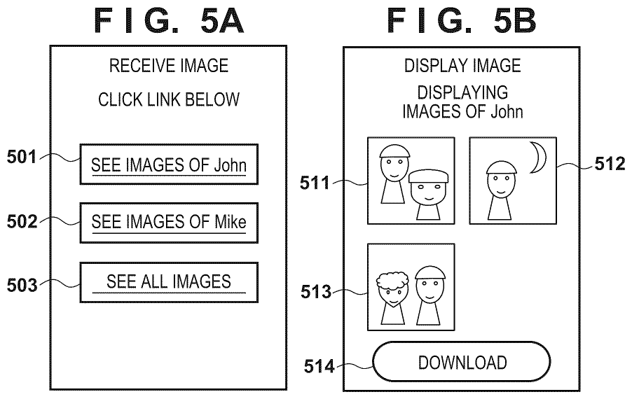

Hereinafter, the flow of processing in which the information processing apparatus 101 transmits link information will be described more specifically using the flowchart of FIG. 3 and the screen examples of FIGS. 4A to 4D, 5A, and 5B. FIG. 4 illustrates an example of screen display on the terminal 102 of the sender, and FIGS. 5A and 5B illustrate examples of screen display on the terminal 103 of the recipient. Hereinafter, it is assumed that the storage 201 stores four images from an image A to an image D uploaded by the sender who operates the terminal 102.

FIG. 4A illustrates an example of a selection screen of the narrowing type generated by the screen generation unit 202 in S301. Buttons 401 to 403 correspond to the respective narrowing types “person”, “capturing place”, and “capturing date and time”. When any one of the buttons 401 to 403 is pressed, the receiver 204 receives in S302 operation information indicating the selected narrowing type from the terminal 102.

FIG. 4B illustrates an example of a selection screen of the narrowing value generated by the screen generation unit 202 in S303. The present screen is a screen in a case where “person” is received as the narrowing type. Toggle buttons 411 to 413 correspond to persons “John”, “Mike”, and “Ken”, respectively. The toggle button is a button for switching between a selected state and a non-selected state. When the toggle button is pressed, the narrowing value corresponding to the person in a non-selected state is brought into a selected state, and that in a selected state is brought into a non-selected state. Icons 414 and 415 indicate the selected state, and indicate that the narrowing values corresponding to “John” and “Mike” are selected, respectively. When a decision button 416 is pressed, operation information indicating the selected narrowing value is transmitted. When the decision button 416 is pressed in a state of the screen illustrated in FIG. 4B, the receiver 204 receives “John” and “Mike” as the operation information indicating the narrowing value in S304.

When the narrowing values of “John” and “Mike” are received, the image narrowing unit 207 generates two narrowing conditions in S305. One narrowing condition A includes the narrowing type “person” and the narrowing value “John”. The other narrowing condition B includes the narrowing type “person” and the narrowing value “Mike”.

FIG. 4C illustrates an example of the image selection screen generated by the screen generation unit 202 in S306. The image selection screen displays an image satisfying either the narrowing condition A or the narrowing condition B. In the present embodiment, the image A, the image B, and an image C satisfy the narrowing condition A, and the image A and an image D satisfy the narrowing condition B. Toggle buttons 421 to 424 correspond to the image A to the image D, respectively. When the toggle button is pressed, the image in a non-selected state is brought into a selected state, and that in a selected state is brought into a non-selected selected state. Icons 425 to 428 are icons indicating the selected state, and indicate that the image A to the image D are selected, respectively. When a decision button 429 is pressed, a selection result of an image on the image selection screen is transmitted to the information processing apparatus 101. When the decision button 429 is pressed in the state of the screen of FIG. 4C, the receiver 204 receives image selection information indicating selection of “image A”, “image B”, “image C”, and “image D” in S307. In the screen of FIG. 4C, an image matching the narrowing result (an image in which the face of John or Mike appears) is displayed, and the user can exclude an undesirable image from the transmission target by removing the selection of that image from them. For example, in a case where exclusion of the image A is designated (in a case where non-selected is set by the toggle button 421), the image A is excluded from the result of the narrowing based on all the narrowing conditions. That is, the image A is excluded from the display target of the display screen generated by all the pieces of link information.

FIG. 4D illustrates an example of the transmission destination selection screen generated by the screen generation unit 202 in S308. Toggle buttons 431 to 433 are toggle buttons corresponding to transmission destination person names “John's Mother”, “Luke's Mother”, and “Mike's Father”, respectively. In the illustrated example, the transmission destinations corresponding to the toggle button 431 and the toggle button 433, “John's Mother” and “Mike's Father”, are in a selected state. When a send button 434 is pressed in the state illustrated in FIG. 4D, the receiver 204 receives operation information represent that the transmission destination person names are “John's Mother” and “Mike's Father” in S309.

As described above, in S310, the link information generation unit 206 generates the link information based on the narrowing condition (the type of narrowing and the narrowing value) and the image selection information received in S307. In the present example, first, the link information generation unit 206 generates link information A based on the narrowing condition A. The link information A causes the screen generation unit 202 to generate a display screen that displays only the images satisfying the narrowing condition A, that is, the image A, the image B, and the image C. Next, the link information generation unit generates link information B based on the narrowing condition B. The link information B causes the screen generation unit 202 to generate a display screen that displays only the images satisfying the narrowing condition B, that is, the image A and the image D. Finally, the link information generation unit 206 generates link information X. The link information X causes the screen generation unit 202 to generate the image selection information received by the receiver 204 in S307, that is, the display screen displaying the image A to the image D.

In S311, the transmitter 203 transmits an e-mail including the link information A, the link information B, and the link information X generated in S310 to e-mail addresses corresponding to the transmission destination person names received in S309. FIG. 5A illustrates an example of an e-mail transmitted in S311. Link buttons 501 to 503 correspond to the link information A, the link information B, and the link information X, respectively. When the recipient of the e-mail selects any of these link buttons 501 to 503, the operation information indicating the selected link information is received by the receiver 204. The designated link information causes the screen generation unit 202 to generate an image display screen. FIG. 5B is an example of a display screen generated by the screen generation unit 202 in a case where the link information A (image of John) is selected by the recipient selecting the link button 501. Display images 511 to 513 are the image A to the image C, respectively. A download button 514 is a download button for the recipient to save, to the terminal 103, an image saved in the information processing apparatus 101.

As described above, according to the first embodiment, the narrowing condition is generated based on the input of the sender, and the link information for displaying an image is generated based on the narrowing condition, whereby the recipient of the link information can be provided with a screen in which a part of a transmission image is narrowed down. In the series of operations, the recipient of the link information does not need to perform an operation in advance such as setting of the narrowing condition, and thus, it is possible to prevent a decrease in convenience of the recipient.

Note that the transmitter 203 uses an e-mail when transmitting link information, but is not limited to this. For example, link information may be transmitted using a short message service, a chat system, a messenger system, or the like. The screen generation unit 202 may display a different narrowing value selection screen depending on the narrowing type. Specifically, in a case where “capturing place” is selected as the narrowing type, a map may be displayed as a screen component, and the user may be caused to designate a specific point on the map or a specific range on the map. In a case where “capturing time” is selected as the narrowing type, a calendar component for designating year, month, and day or a clock component for designating time may be displayed as a screen component, and the user may be caused to designate a specific date and time range.

### Variation Example

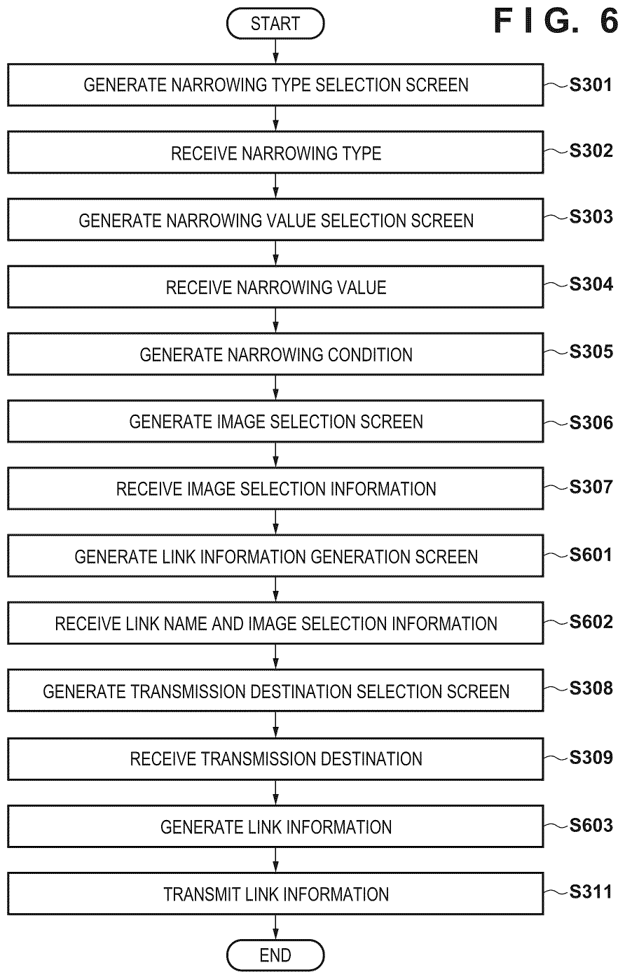

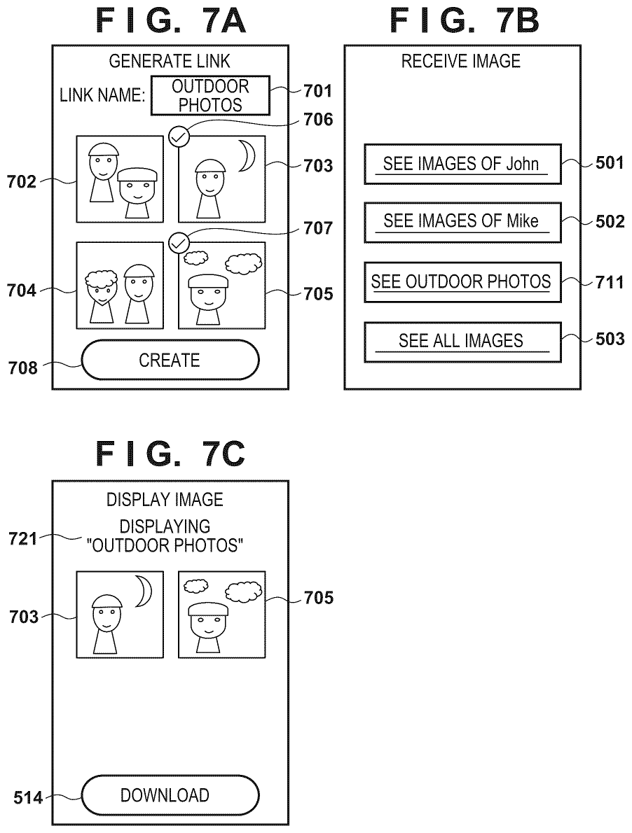

In the above, the link information generation unit 206 automatically generates a plurality of pieces of link information in response to the designated narrowing type and narrowing value. In a variation example, in addition to the automatically generated link information, the user can directly select an image to generate link information. Therefore, the screen generation unit 202 of the variation example causes the sender to select an image to be included in the link information, and generates a screen (described later with reference to FIG. 7A) for generating additional link information. Hereinafter, the variation example will be described with reference to FIGS. 6 and 7A to 7C.

FIG. 6 is a flowchart showing an example of generation processing of link information executed by the information processing apparatus 101. The processing shown in FIG. 6 is implemented by the calculation unit 113 of the information processing apparatus 101 executing a program stored in the storage part 112. The processing shown in FIG. 6 is started at the timing when the receiver 204 receives, from the terminal 102, an input instructing start of selection and transmission processing of an image. Note that S301 to S311 are processes similar to those in FIG. 3.

In S601, the screen generation unit 202 generates a link information generation screen. FIG. 7A is an example of the link information generation screen generated by the screen generation unit 202. A link name input area 701 is an area for causing the sender to input the link name of the link information to be newly generated. Toggle buttons 702 to 705 correspond to the image A to the image D, respectively. When the toggle button corresponding to an image in a non-selected state is pressed, the image is brought into a selected state, and when the toggle button corresponding to an image in a selected state is pressed, the image is brought into a non-selected state. Icons 706 and 707 are icons indicating the selected state, and indicate that the image B and the image D are selected, respectively. When a creation button 708 is pressed, operation information indicating the link name designated in the link name input area 701 and the image selected by the toggle buttons 702 to 705 is transmitted to the information processing apparatus 101. When the creation button 708 is pressed in a state of the screen illustrated in FIG. 7A, the receiver 204 receives in S602 “outdoor photos” as an input indicating the link name and “image B” and “image D” as inputs indicating the image selection information.

Thereafter, the process proceeds to S603 through the processes of S308 to S309. In S603, similarly to S310, the link information generation unit 206 generates the link information based on the narrowing condition (the type of narrowing and the narrowing value) and the image selection information received in S307. For example, the link information generation unit 206 generates the pieces of link information A, B, and X. Here, the link information generation unit 206 of the variation example generates, in addition to these pieces of link information, link information C based on the input (the link name and the image selection information) received in S602. For example, the link information C has a link name “outdoor photo”, and causes the screen generation unit 202 to generate a display screen displaying the image selection information received by the receiver 204, that is, the image B and the image D.

In S311, the transmitter 203 transmits an e-mail including the link information A, the link information B, the link information C, and the link information X generated in S603 to the e-mail address corresponding to the transmission destination person name received in S309. FIG. 7B illustrates an example of the e-mail sent in S311. A link button 711 corresponds to the link information C. When the sender selects the link button 711, the receiver 204 receives selection of the link information C and causes the screen generation unit 202 to generate a display screen of an image. FIG. 7C is an example of a display screen generated by the screen generation unit 202 when the recipient selects the link information C. A link name 721 indicates “outdoor photo” (link name designated in the link name input area 701), which is the link name of the link information C. Display images 703 and 705 are the image B and the image D selected in FIG. 7A, respectively.

In the first embodiment described above, an example in which one or more narrowing conditions are defined by one or more narrowing values set for one narrowing type selected from a plurality of narrowing types has been described. For example, an example has been described in which two pieces of narrowing information are defined by selecting one (face) from a plurality of narrowing types using the screen of FIG. 4A and setting one or more narrowing values (John and Mike) for the narrowing type in FIG. 4B. However, the present invention is not limited to this, and a plurality of narrowing types may be selectable. In this case, for example, one or more first narrowing conditions defined by each of one or more narrowing values set for the first narrowing type among a plurality of narrowing types are obtained. One or more second narrowing conditions defined by each of one or more narrowing values set for a second narrowing type different from the first narrowing type among the plurality of narrowing types are obtained. By combining the one or more first narrowing conditions and the one or more second narrowing conditions thus acquired, one or more narrowing conditions used for narrowing down the image can be obtained.

In order to enable a plurality of narrowing types to be selected, for example, on the screen of FIG. 4A, the buttons 401 to 403 indicating the narrowing type may be used as toggle switches to enable the plurality of narrowing types to be selected. In this case, the plurality of narrowing types selected by the operation of a decision button not illustrated is transmitted to the information processing apparatus 101. Alternatively, the screen of FIG. 4B may be added with a return button, and when the return button is pressed, the screen may return to the screen of FIG. 4A and an additional narrowing type may be selectable. Note that in a case where a plurality of narrowing types are selected, a screen for setting a narrowing value regarding each narrowing type is sequentially displayed, and the user can set the narrowing value for each narrowing type.

The combination of the one or more first narrowing conditions and the one or more second narrowing conditions described above includes combining, by AND, for example, each of the one or more first narrowing conditions and each of the one or more second narrowing conditions. For example, it is assumed that the first narrowing type is “person”, the narrowing values are “John” and “Mike”, the second narrowing type is “capturing date and time”, and the narrowing value is “past one month”. In this case, the narrowing conditions are two of [person: John] AND [capturing time: past one month] and [person: Mike] AND [capturing time: past one month]. It is also possible to combine, by OR, narrowing conditions by a plurality of narrowing types. In this case, for example, in the above example, the narrowing conditions are two of [person: John] OR [capturing time: past one month] and [person: Mike] OR [capturing time: past one month]. The user may be able to designate, from the terminal 102, whether to combine conditions by a plurality of narrowing types by AND or by OR. Note that in a case where three or more narrowing types are selected, they can be combined by a similar method.

### Second Embodiment

In the first embodiment, the recipient of the image receives the link information generated based on an input of the sender. On the other hand, there is a case where the recipient has narrowed down and displayed the image based on a specific narrowing condition set by the recipient using the same terminal 103 in the past. At this time, there is a possibility that the recipient desires to narrow down the images received from the sender by using the narrowing conditions used in the past. However, in the first embodiment, it is not considered to generate the narrowing condition based on the information on the recipient. Therefore, in the second embodiment, a configuration will be described in which in a case where the recipient has browsed an image in the past using the terminal 103 and the operation information is stored in the storage 201, the link information generation unit 206 generates link information using the operation information.

### Display Processing of Link Information

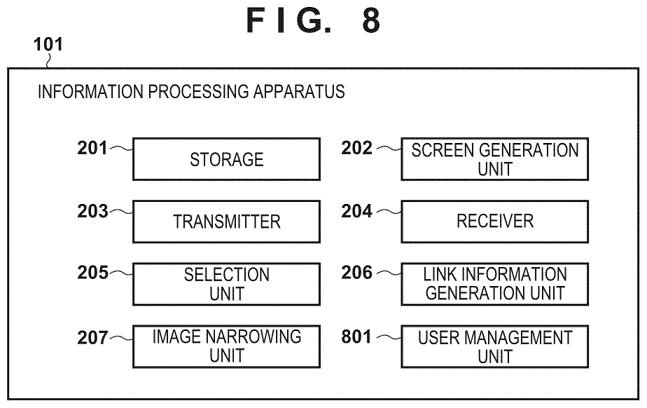

FIG. 8 is a block diagram illustrating a software configuration example of the information processing apparatus 101 according to the second embodiment. The configuration of the first embodiment (FIG. 2) is added with a user management unit 801. The user management unit 801 specifies the operation information of the user based on authentication information of the user received via the receiver 204. The user management unit 801 updates the operation information of the user based on the information received by the receiver 204.

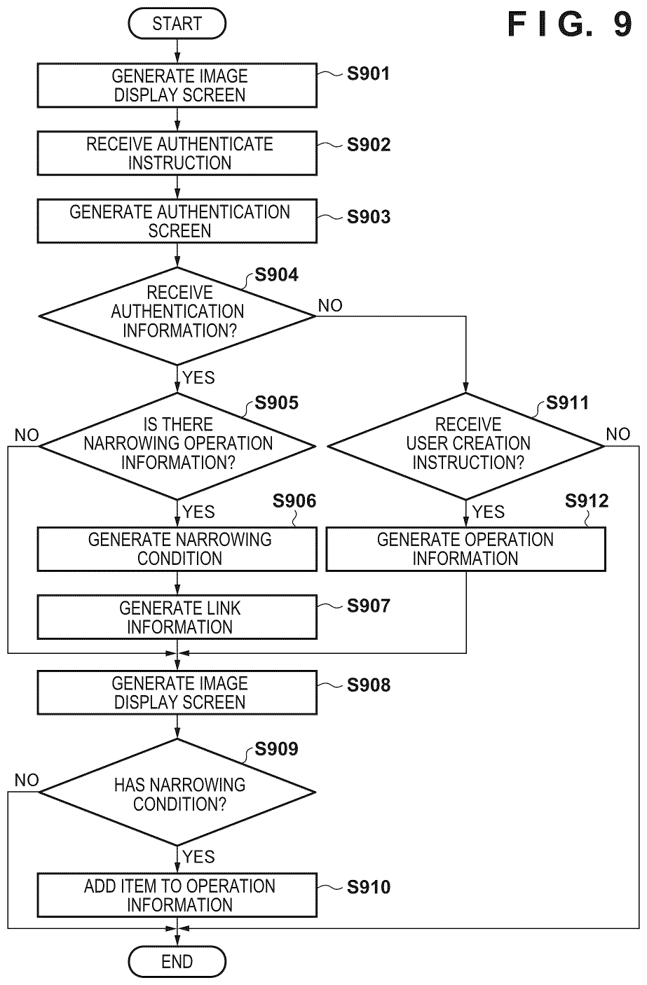

FIG. 9 is a flowchart showing an example of transmission processing of link information executed by the information processing apparatus 101. The processing shown in FIG. 9 is implemented by the calculation unit 113 of the information processing apparatus 101 executing a program stored in the storage part 112. The processing shown in FIG. 9 is started at the timing, for example, when the recipient designates the link information from the screen of FIG. 5A.

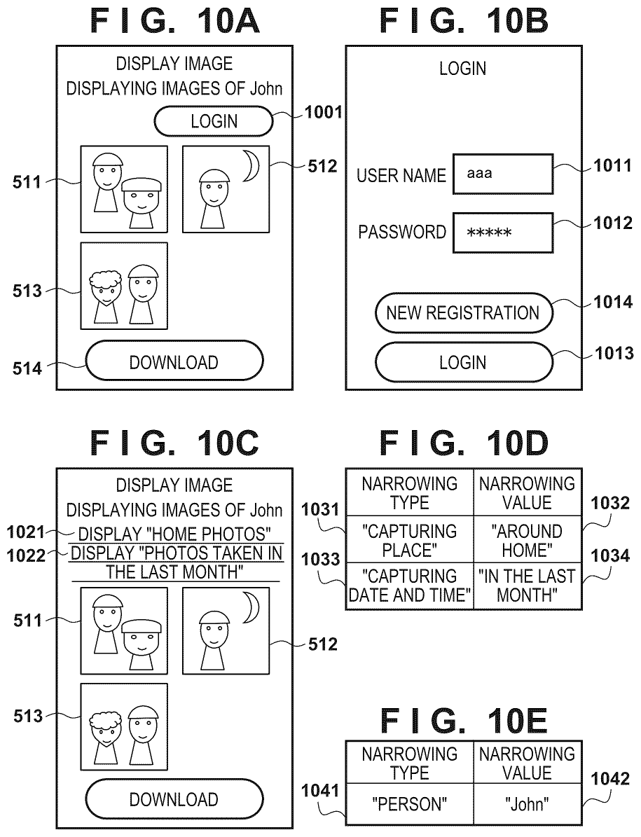

In S901, the screen generation unit 202 generates a display screen based on the link information designated by the recipient. However, at this time, the screen generation unit 202 displays, on the screen, a component (e.g., a login button 1001 of FIG. 10A) for performing user authentication. When execution of the user authentication is instructed (e.g., when the login button 1001 is pressed), the receiver 204 receives in S902 the instruction of the user authentication as the operation information. When the instruction of the user authentication is received by the receiver 204, the screen generation unit 202 generates a user authentication screen (e.g., the screen of FIG. 10B) in S903. In S904, the screen generation unit 202 determines whether or not the user authentication information has been received by the receiver 204. In the present embodiment, the user authentication information is a set of a user ID and a password. In S904, for example, in a case where the user name and password input on the screen of FIG. 10B are transmitted by pressing of a login button 1013, the user authentication information is received. In a case where it is determined that the user authentication information has been received (YES in S904), the process proceeds to S905.

In S905, the user management unit 801 determines whether or not there is information on the operation history of the user based on the user authentication information received in S904. The information on the operation history mentioned here is a narrowing condition used by the user in the past, and includes, for example, a pair of a narrowing type and a narrowing value. Hereinafter, the information on this operation history is called narrowing operation information. In a case where it is determined that the narrowing operation information exists (YES in S905), the process proceeds to S906, and in a case where it is determined that the narrowing operation information does not exist (NO in S905), the process proceeds to S908. In S906, the image narrowing unit 207 acquires narrowing information of the user, and generates the narrowing condition based on the acquired narrowing operation information. As illustrated in FIG. 10D, the narrowing operation information includes one or a plurality of items, and each item includes a pair of a narrowing type and a narrowing value. The image narrowing unit 207 generates narrowing conditions by the number of items included in the narrowing operation information. Therefore, each narrowing condition to be generated includes a narrowing type and a narrowing value of each item of the narrowing operation information. In S907, the link information generation unit 206 generates link information based on the narrowing condition generated in S906 and the image selection information received in S307.

In S908, the screen generation unit 202 generates a display screen in which the display screen generated in S901 is added with a link display for selecting the link information generated in S907 (described later with reference to FIG. 10C, for example). However, since the login is completed at this time point, the login button 1001 is not displayed. When the link information is not generated in S907, the display screen is not added with link display. In S909, the user management unit 801 determines whether or not the link information (in the present example, the link information designated on the screen of FIG. 5A) has information on the narrowing condition. For example, in a case where the link button 501 is selected, a narrowing condition is included in which the narrowing type is “person” and the narrowing value is “John”. On the other hand, in a case where the link button 503 (see all images) is selected, no narrowing condition is included. In a case where the information of the narrowing condition is included (YES in S909), the process proceeds to S910, and when the narrowing condition is not included (NO in S909), the present processing is ended. In S910, the user management unit 801 updates the operation information by adding an item to the narrowing operation information of the user (user who has logged in from the screen of FIG. 10B) based on the information on the narrowing condition included in the link information, and ends the present processing. The item to be added includes a narrowing item and a narrowing value constituting a narrowing condition.

Flow of Display Process of Link Information

Hereinafter, a specific operation example by the processes of S901 to S910 described above with reference to FIG. 9 will be described using screen examples of FIGS. 10A to 10E. In the following example, it is assumed that the storage 201 stores four images from the image A to the image D. It is assumed that the recipient who owns the terminal 103 has received an e-mail including the link information A, the link information B, and the link information X. It is assumed that the recipient has designated the link information A. It is assumed that the storage 201 has stored narrowing operation information of the recipient illustrated in FIG. 10D.

In S901, the screen generation unit 202 generates a display screen based on the link (link information A) selected in FIG. 5A (or FIG. 7B). FIG. 10A is an example of a display screen of a link destination generated by the screen generation unit 202 at this time and displayed on the terminal 103. When the login button 1001 is pressed, the receiver 204 receives an instruction to display the user authentication screen in S902. When the instruction to display the user authentication screen is received by the receiver 204, the screen generation unit 202 generates the user authentication screen in S903, and the terminal 103 receives and displays this user authentication screen. FIG. 10B is an example of a user authentication screen displayed on the terminal 103. The user authentication screen includes a user name input area 1011 and a password input area 1012. When the login button 1013 is pressed after the user name (user ID) and the password are input in the user name input area 1011 and the password input area 1012, the user name and the password that are input are transmitted to the information processing apparatus 101. In S904, the receiver 204 receives the user name and the password that are input in the user name input area 1011 and the password input area 1012.

The user management unit 801 determines whether operation information (narrowing operation information) exists for the recipient specified by the user name and the password (S905). Here, in a case where the narrowing operation information as illustrated in FIG. 10D is recorded for the recipient (YES in S905), the image narrowing unit 207 generates a narrowing condition based on the narrowing operation information of the recipient illustrated in FIG. 10D (S906). In the example of FIG. 10D, the image narrowing unit 207 generates a narrowing condition C in which the narrowing type is “capturing place” and the narrowing value is “close to home” from information 1031 and information 1032. In a case where the information of the capturing place embedded in an image is included in a range of position information such as latitude and longitude indicating what is close to home designated in advance, the image narrowing unit 207 determines that the image satisfies the narrowing condition C. The image narrowing unit 207 generates a narrowing condition D in which the narrowing type is “capturing date and time” and the narrowing value is “past one month” from information 1033 and 1034. For example, in a case where a difference between the capturing time embedded in the image and the current time is within one month, the image narrowing unit 207 determines that the image satisfies the narrowing condition D.

The link information generation unit 206 generates the link information C and link information D based on the narrowing condition C and the narrowing condition D (S907). In a case where the narrowing condition of the link information selected in FIG. 5A is already recorded in the narrowing operation information, the link information is not newly generated for the narrowing condition. Then, the screen generation unit 202 removes the login button 1001 from the display screen of FIG. 10A, and generates a display screen added with link display 1021 and 1022 indicating the link information C and the link information D (S908). FIG. 10C is an example of a display screen generated at this time. In this manner, the screen on which the link information based on the operation history of the user is superimposed and displayed is displayed on the screen of the link destination indicated by the link information selected on the screen of FIG. 5A. The link information (link information corresponding to the link button 501) selected in FIG. 5A has a narrowing condition (here, the narrowing type is “person” and the narrowing value is “John”). Therefore, the narrowing condition is added to the narrowing operation information (S909, S910). Note that in a case where the narrowing condition is already recorded as the narrowing operation information, the narrowing operation information is not updated.

### New Registration of Narrowing Operation Information

Next, processing of newly registering narrowing operation information by newly registering the user will be described. In a case where a new registration button 1014 is pressed on the screen of FIG. 10B, it is determined that a user creation instruction has been received. In this case, NO is determined in S904 of FIG. 9, and YES is determined in S911. The user creation instruction is a set of a user ID and a password, and the user management unit 801 manages the user by a character string described in the user name input area 1011 and the password input area 1012. In S912, the user management unit 801 generates narrowing operation information of the user in association with the user ID and the password received by the receiver 204. At this time point, nothing is recorded in the narrowing operation information. Then, in S908, the screen generation unit 202 generates a display screen in which the display screen generated in S901 is added with a display indicating that user registration has been newly performed. In S909, the user management unit 801 determines whether or not the link information has information of a narrowing condition. In a case where the information of the narrowing condition is included (YES in S909), the process proceeds to S910, and in a case where the information is not included (NO in S909), the present process is ended. In S910, the user management unit 801 adds an item to the narrowing operation information based on the information on the narrowing condition included in the link information, and ends the process of the present flowchart. For example, the narrowing condition included in the link information selected on the screen of FIG. 5A is registered as narrowing operation information.

### Flow of Update Process of Operation Information

Hereinafter, the flow of processing in which the information processing apparatus 101 updates the operation information will be described using the flowchart shown in FIG. 9 and the screen example of FIG. 10B. Hereinafter, it is assumed that the storage 201 stores four images from the image A to the image D. It is assumed that the recipient has received an e-mail including the link information A, the link information B, and the link information X and has designated the link information A.

When the new registration button 1014 is pressed on the user authentication screen of FIG. 10B, the receiver 204 receives a user creation instruction including the user name and the password that are input in the user name input area 1011 and the password input area 1012 (S911). When the user creation instruction is received, the user management unit 801 generates narrowing operation information of the recipient (S912). At this time, the narrowing operation information has no item. Since the link information A has the narrowing condition A, the user management unit 801 determines that the designated link information A has the narrowing condition (YES in S909), and adds an item to the narrowing operation information based on the information of the narrowing condition A (S910). FIG. 10E illustrates a state in which an item is added to the narrowing operation information that is newly generated. The added item includes a narrowing type 1041 and a narrowing value indicated by a narrowing value 1042. The narrowing type 1041 indicates “person”, which is the narrowing type of the narrowing condition A. The narrowing value 1042 indicates “John”, which is the narrowing value of the narrowing condition A.

As described above, in the second embodiment, the narrowing condition is generated based on the operation information of the recipient, and the link information for displaying an image is generated based on the narrowing condition, whereby the recipient of the link information can be provided with a screen in which a part of a transmission image is narrowed down.

Note that the user management unit 801 may display an error in response to the user authentication information received in S904 and end the flowchart. Specifically, it may be determined whether or not the set of the user name and the password having been received matches the set of the user name and the password given in advance, and in a case of not matching, an error may be displayed.

Note that information other than the set of the user ID and the password may be used as the user authentication information. For example, information such as a one-time password, fingerprint information, and face information may be used.

### Other Embodiments

While an example of the process of the information processing apparatus 101 has been described above, the present invention is not limited to the above-described embodiments, and various variations may be made. Parts of the above-described embodiments may be appropriately combined. At least a part of the process described in each of the embodiments may be implemented by one or a plurality of pieces of dedicated hardware different from the calculation unit 113. The information processing apparatus 101 may include an authentication system, and the communication unit 111 may add a user ID and a password to the content of communication with the terminal. The content of communication with the terminal may be encrypted and transmitted/received.

According to the present invention, it is possible to browse a selected image while reducing an operation burden on a sender and a recipient.

Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-170866, filed Sep. 29, 2023, which is hereby incorporated by reference herein in its entirety.

What is claimed is:

1. An information processing apparatus comprising:
a storage unit configured to store a plurality of images;
a reception unit configured to receive one or more narrowing conditions from an external apparatus;
a generation unit configured to generate one or more pieces of first link information each representing a link to a screen displaying an image satisfying each of the one or more narrowing conditions among the plurality of images; and
a transmission unit configured to transmit the one or more pieces of first link information to a transmission destination designated by the external apparatus.

2. The information processing apparatus according to claim 1, wherein
the generation unit generates second link information representing a link to a screen displaying all images satisfying at least one of the one or more narrowing conditions, and
the transmission unit transmits the one or more pieces of first link information and the second link information to the transmission destination.

3. The information processing apparatus according to claim 2 further comprising:
a first selection unit configured to select, from the external apparatus, an image to be excluded from among images satisfying at least one of the one or more narrowing conditions,
wherein the selected image is excluded from screens linked by each of the one or more pieces of first link information and the second link information.

4. The information processing apparatus according to claim 3, wherein the first selection unit provides the external apparatus with a screen that displays all images satisfying at least one of the one or more narrowing conditions and allows a user to select an image to be excluded.

5. The information processing apparatus according to claim 1, wherein the one or more narrowing conditions are defined by one or more narrowing values set for one narrowing type selected from a plurality of narrowing types.

6. The information processing apparatus according to claim 1, wherein the one or more narrowing conditions are obtained by combining one or more first narrowing conditions each defined by one or more narrowing values set for a first narrowing type among a plurality of narrowing types and one or more second narrowing conditions each defined by one or more second narrowing values set for a second narrowing type different from the first narrowing type among the plurality of narrowing types.

7. The information processing apparatus according to claim 6, wherein
for the combination, any of a combination by AND of each of the one or more first conditions and each of the one or more second conditions and a combination by OR of the one or more first conditions and the one or more second conditions is used, and
which to use the combination by AND and the combination by OR is designated by the external apparatus.

8. The information processing apparatus according to claim 5, wherein the plurality of narrowing types include narrowing by a person, narrowing by a capturing place, and narrowing by a capturing time.

9. The information processing apparatus according to claim 1 further comprising:
a second selection unit configured to select, from the external apparatus, one or a plurality of images from among images satisfying at least one of the one or more narrowing conditions,
wherein the generation unit generates third link information indicating a link to a screen displaying the one or plurality of images selected by the second selection unit.

10. The information processing apparatus according to claim 1 further comprising:
a management unit configured to manage, as an operation history of a user, a narrowing condition corresponding to link information selected by a user operation from among link information transmitted by the transmission unit,
wherein the generation unit acquires an operation history of the user of the transmission destination from an operation history managed by the management unit, and generates fourth link information indicating a link to a screen for displaying an image satisfying a narrowing condition included in the acquired operation history, and
the transmission unit transmits the fourth link information to the transmission destination.

11. The information processing apparatus according to claim 10, wherein the fourth link information is displayed in a superimposed manner on a screen of a link destination based on link information selected from the one or more pieces of first link information.

12. An information processing system comprising: a terminal apparatus; and an information processing apparatus including a storage unit configured to store a plurality of images, the information processing apparatus including
a reception unit configured to receive one or more narrowing conditions designated by a user in the terminal apparatus,
a generation unit configured to generate one or more pieces of first link information each representing a link to a screen displaying an image satisfying each of the one or more narrowing conditions among the plurality of images, and
a transmission unit configured to transmit the one or more pieces of first link information to a transmission destination designated by the user in the terminal apparatus.

13. A control method of an information processing apparatus including a storage unit configured to store a plurality of images, the control method comprising:
receiving one or more narrowing conditions from an external apparatus;
generating one or more pieces of first link information each representing a link to a screen displaying an image satisfying each of the one or more narrowing conditions among the plurality of images; and
transmitting the one or more pieces of first link information to a transmission destination designated by the external apparatus.

14. A non-transitory computer-readable storage medium storing a program for causing a computer to execute a control method of an information processing apparatus including a storage unit configured to store a plurality of images, the control method comprising:
receiving one or more narrowing conditions from an external apparatus,
generating one or more pieces of first link information each representing a link to a screen displaying an image satisfying each of the one or more narrowing conditions among the plurality of images, and
transmitting the one or more pieces of first link information to a transmission destination designated by the external apparatus.
